(19) United States
(12) Patent Application Publication
(10) Pub. No.: US 2009/0263772 A1
(43) Pub. Date: Oct. 22, 2009

(54) Physical education system

(76) Inventors: Tom Root, Valencia, CA (US); Ryan Root, Valencia, CA (US)

Correspondence Address: CHRISTIE, PARKER & HALE, LLP, PO BOX 7068, PASADENA, CA, 91109-7068, US

(21) Appl. No.: 12/384,378

(22) Filed: Apr. 3, 2009

Related U.S. Application Data
(60) Provisional application No. 61/124,851, filed on Apr. 18, 2008.

(51) Int. Cl. G09B 19/00

(52) U.S. Cl. 434/247

(57) ABSTRACT

A method for group teaching of physical activity. The method includes: selecting a video, wherein the video displays instructions for at least one physical activity; assembling selected exercise equipment, wherein the exercise equipment is selected based on the instructions displayed in the video and a number of participants in the group; positioning the exercise equipment in selected positions, wherein the exercise equipment is positioned based on the instructions displayed in the video; assigning participants to stations, wherein the participants are assigned to the stations based on the instructions displayed in the video; playing the video, wherein the participants are instructed to participate in the at least one physical activity by following the instructions displayed in the video; and monitoring compliance, technique, and condition of the participants as the participants perform aspects of the at least one physical activity. The physical fitness of the participants is improved by performance of the at least one physical activity.

### CROSS-REFERENCE TO RELATED PATENT APPLICATION

This application claims priority to and the benefit of U.S. Provisional Patent Application No. 61/124,851 filed Apr. 18, 2008, the entire content of which is incorporated herein by reference.

### FIELD OF THE INVENTION

The present invention relates to a physical education and training system, and a method for implementing a physical education and training system.

### BACKGROUND OF THE INVENTION

With medical research indicating the beneficial aspects of exercise in light of decreases in physical activity resulting from modern lifestyles, there is a growing need for exercise programs that achieve sufficient beneficial physical activity in a method that is compatible with the daily lives of both adults and children.

### SUMMARY OF THE INVENTION

An aspect of the present invention is directed toward a physical education and training system, and a method for implementing a physical education and training system.

An embodiment of the present invention provides a method for group teaching of physical activity. The method includes: selecting a video, wherein the video displays instructions for at least one physical activity; assembling selected exercise equipment, wherein the exercise equipment is selected based on the instructions displayed in the video and a number of participants in the group; positioning the exercise equipment in selected positions, wherein the exercise equipment is positioned based on the instructions displayed in the video; assigning participants to stations, wherein the participants are assigned to the stations based on the instructions displayed in the video; playing the video, wherein the participants are instructed to participate in the at least one physical activity by following the instructions displayed in the video; and monitoring compliance, technique, and condition of the participants as the participants perform aspects of the at least one physical activity. The physical fitness of the participants is improved by performance of the at least one physical activity.

The video may display a split screen format, wherein a portion of the screen displays an aspect of the at least one physical activity and another portion of the screen displays a subject selected from a group of subjects including educational information, nutritional information, test questions, test question answers, and entertainment.

The video may display a split screen format, wherein a portion of the screen displays an aspect of the at least one physical activity and another portion of the screen displays another aspect of the at least one physical activity.

The video may display instructions for circuit training by instructing participants to rotate through at least two stations and the method further includes: selecting positions for each station, wherein the positions are selected based on instructions displayed in the video; and dividing the participants into a number of groups that equals the number of stations.

The video may display a split screen format, wherein a portion of the screen displays a physical activity for a station and another portion of the screen displays a different physical activity for a different station.

The exercise equipment may be selected from a group of exercise equipment including a configurable mat that can be configured into suitable sizes or configured as a hurdle, a mat, or a ladder; a ball; a jump rope; an exercise band; and a flexible pole.

The exercise equipment may include a mat, wherein the mat has labeled regions that correspond to instructions displayed in the video.

The method may further include: playing the video on a computer located on an audio visual equipment cart, wherein the audio portion of the video is played through a sound system, and the visual portion of the video is played through a projector located on the audio visual equipment cart.

The method may further include monitoring the heart rate of at least one participant by locating a heart rate monitoring device that transmits a signal on the at least one participant, and receiving the signal with a peripheral observation device, wherein the peripheral observation device sends the signal to a computer with software for recording the heart rate of the at least one participant.

The video may display instructions for at least one technique for the at least one physical activity, which at least one physical activity is selected from the group including: football, soccer, swimming, yoga, dance, baseball, Pilates, martial arts, golf, volleyball, and hockey.

Another embodiment of the present invention provides a physical education system. The system includes: a selected video, wherein the video displays instructions for at least one physical activity; and exercise equipment, wherein the exercise equipment is selected based on the instructions displayed in the video and a number of participants in the group. The exercise equipment is assembled and positioned based on the instructions displayed in the video. The participants are assigned to the exercise equipment based on the instructions displayed in the video. The participants participate in the at least one physical activity by following the instructions displayed in the video. Compliance, technique, and condition of the participants is monitored as the participants perform the at least one physical activity.

### BRIEF DESCRIPTION OF THE DRAWINGS

The patent or application file contains at least one drawing executed in color. Copies of this patent or patent application publication with color drawings will be provided by the Office upon request and payment of the necessary fee.

The patent or application file contains at least one drawing/picture executed in color. Copies of this patent or patent application publication with color drawing/picture(s) will be provided by the Office upon request and payment of the necessary fee.

FIG. 1 is a flow chart of a training method of an embodiment of the present invention;

FIG. 2 is a flow chart of split-screen video content of an embodiment of the present invention;

FIG. 3 is a view of a split-screen video display of an embodiment of the present invention;

FIG. 4 is a flow chart of a mat training method of an embodiment of the present invention;

FIG. 5 is a schematic view of a mat of an embodiment of the present invention;

FIG. 6A is a view of mats of an embodiment of the present invention;

FIG. 6B is another view of mats of an embodiment of the present invention;

FIG. 7 is a block diagram view of system equipment of an embodiment of the present invention;

FIG. 8 is a flow chart of a circuit training method of an embodiment of the present invention;

FIG. 9 is a view of equipment of an embodiment of the present invention;

FIG. 10 is a view of stations of a circuit training method of an embodiment of the present invention;

FIG. 11 is another view of stations of a circuit training method of an embodiment of the present invention;

FIG. 12 is another view of stations of a circuit training method of an embodiment of the present invention;

FIG. 13 is a flow chart of circuit video content of an embodiment of the present invention;

FIG. 14 is a view of another split-screen video display of an embodiment of the present invention;

FIG. 15 is a flow chart of sports specific video content of an embodiment of the present invention;

FIG. 16 is a flow chart of dance video content of an embodiment of the present invention; and

FIG. 17 is a flow chart of yoga video content of an embodiment of the present invention.

### DETAILED DESCRIPTION

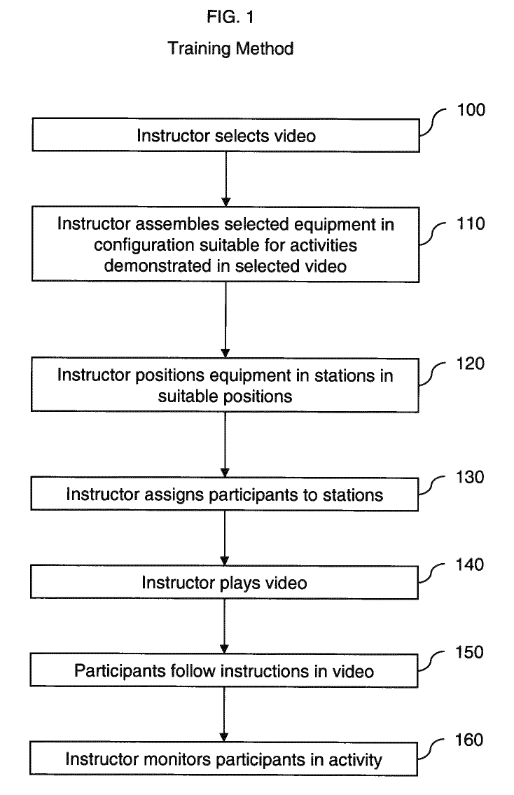

An embodiment of the present invention provides a physical education and training system, and a method for implementing a physical education and training system. As shown in FIG. 1, an instructor selects an instructional video 100, and assembles selected equipment in a configuration that is suitable for activities that will be demonstrated in the video 110. The instructor then positions the equipment in stations in suitable positions 120, and assigns participants to the stations 130. Next, the instructor plays the video 140 and the participants follow the instructions presented in the video 150. The instructor monitors the participants as they follow the instructions presented in the video 160, providing assistance and additional directions as needed.

The instructor may select amongst multiple different types of videos that provide instruction in different physical activities. For example, the video may show calisthenics-type exercises, such as bent-knee squats, forward bent-knee lunges, lifting the knee to the chest while standing, jumping jacks, and/or hopping on one foot from a first position to a second position. Further, the video may show dance moves, sports techniques, aerobics-type movements involving bouncing, jump rope techniques, martial arts techniques, yoga poses, Pilates exercises, and/or other physical activities. Further, videos may be specialized for intended participants. For example, videos may be directed toward different age groups of children, physical education classes, gym classes, adult groups, or senior adult groups.

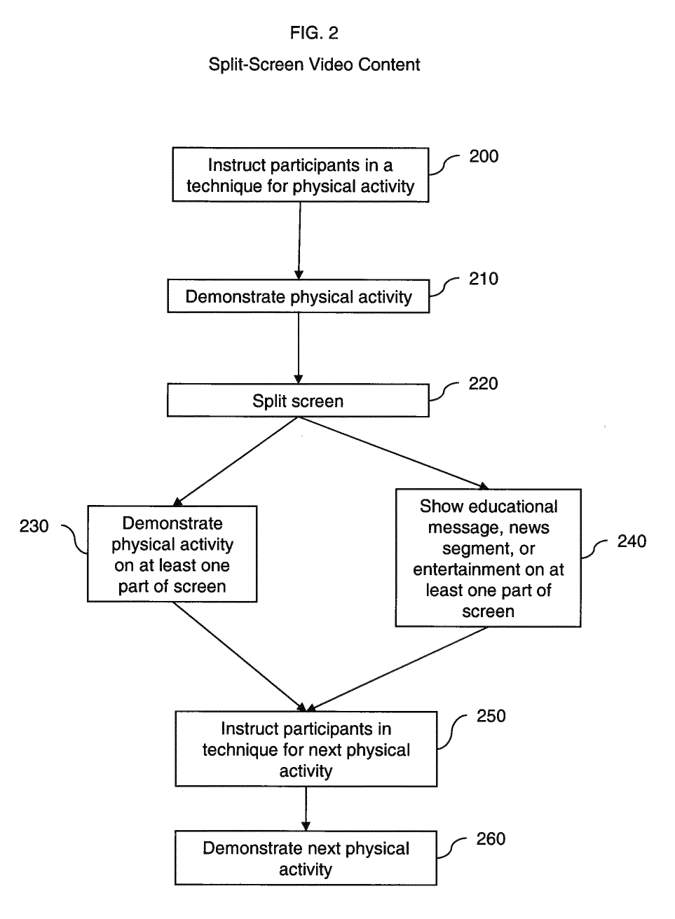

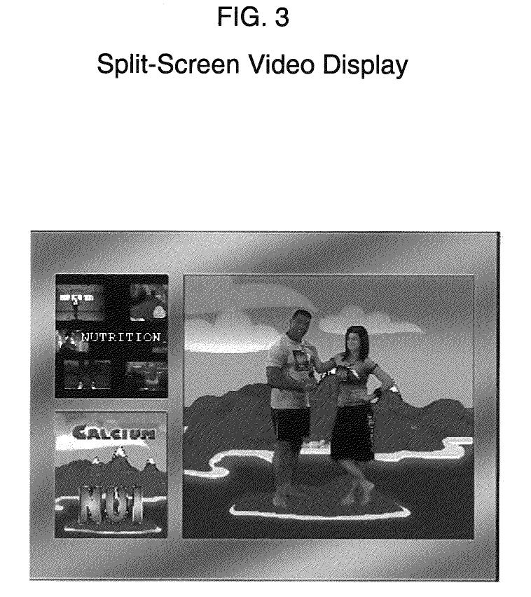

As shown in FIG. 2, the video may include content in a split-screen type format. Here, the video may instruct participants in a technique for physical activity 200, and show a demonstration of that technique on the video screen 210. Next, the screen may be split into regions showing different video content in each region 220, an example of which is shown in FIG. 3. For example, one region of the screen may continue to show a demonstration of the technique 230. In another region of the screen, the technique may be demonstrated from another viewing angle. In another region of the screen, other video content may be shown 240, such as health and fitness information, nutritional information, anti-smoking messages, news segments, or cartoons. After completion of practice of the first technique, the video may return to a single screen format for instruction in technique for next physical activity 250, and demonstration of the next technique 260 before returning to the split-screen type format. This process can continue until all of the techniques have been practiced. The video may provide instruction for four to eight techniques, but is not limited thereto.

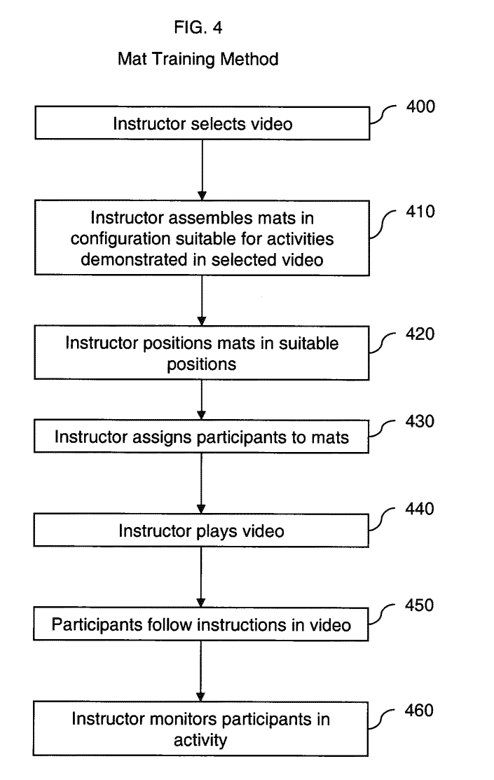

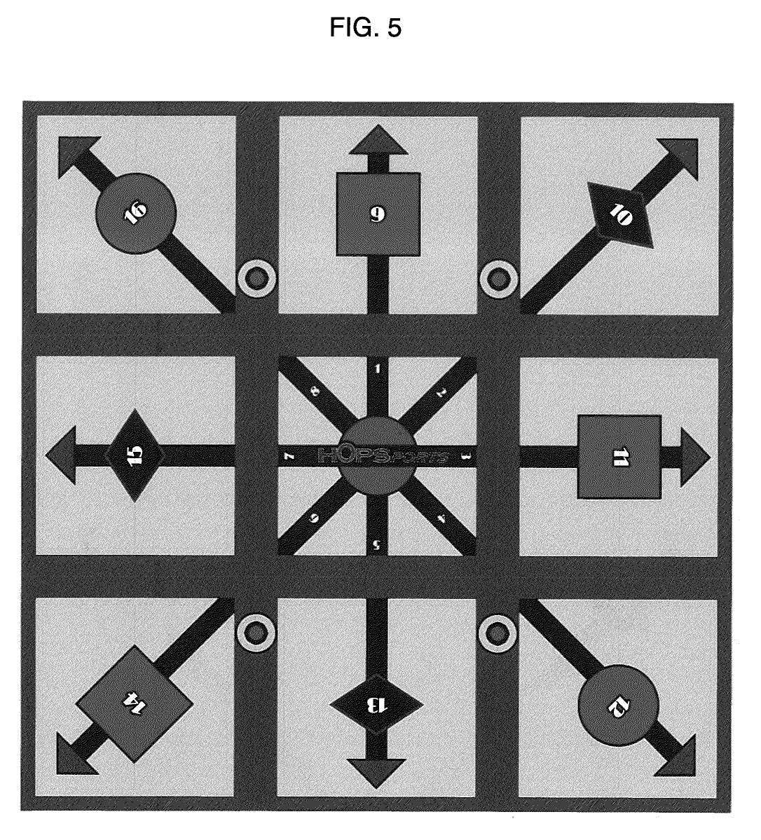

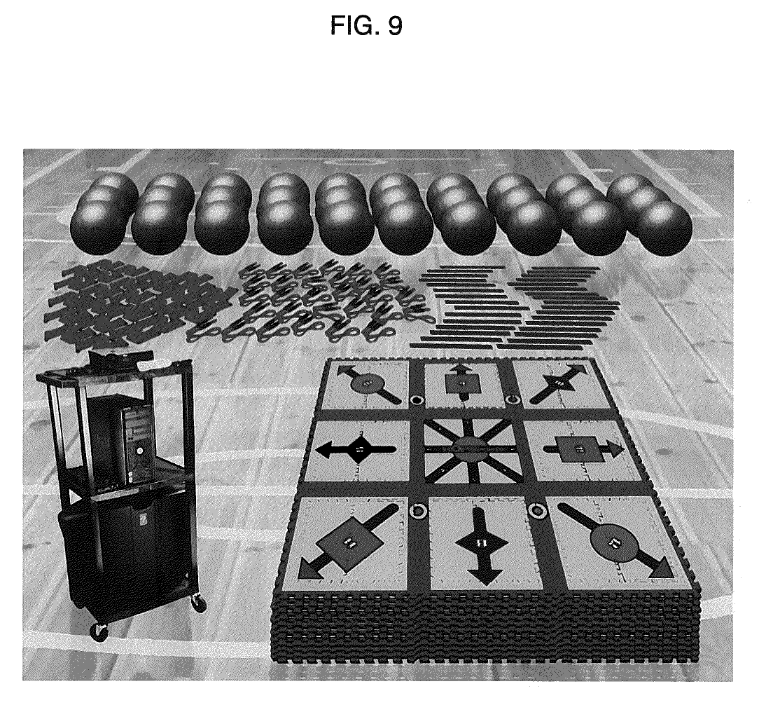

The video may provide instruction in utilizing equipment. As shown in FIG. 9, this equipment may include, but is not limited to, mats (e.g., configurable mats suitable for use in performing exercises), balls, (e.g., large deformable exercise balls, soccer balls, etc.), flexible poles (e.g., foam cylinders or sticks), elastic bands, cones, and/or hurdles. For example, as shown in FIG. 4, the video may provide instruction in utilizing a mat. Here, the instructor selects a video 400 and assembles mats in a configuration that is suitable for activities demonstrated in the selected video 410. FIG. 5 shows an example of a mat that may be utilized with the video. Here, the mat has labeled regions. The video may instruct the participant to move parts of the body, such as a foot or a hand, towards a region of the mat by referring to the labeled region. This feature is useful to help participants understand the instruction of the technique demonstrated on the video. Further, a mat that includes detachable interlocking sections may be utilized so that the mat may be configured suitably for different techniques and exercises.

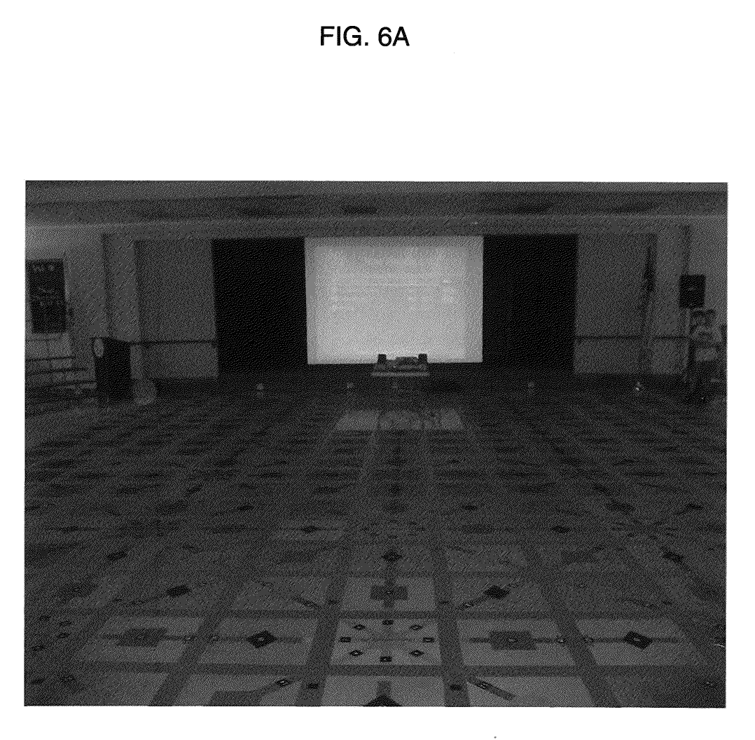

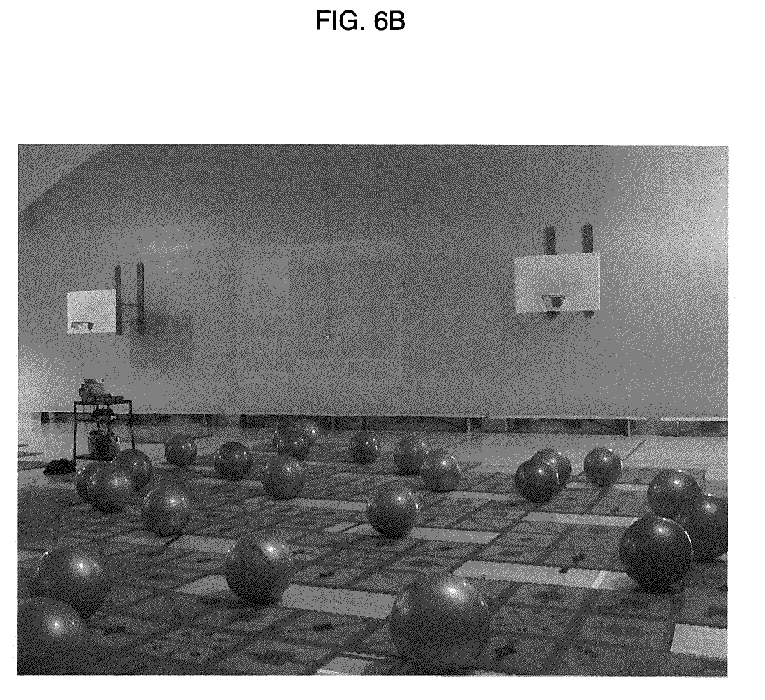

Next, as shown in FIG. 4, the instructor positions the mats in suitable positions 420, and assigns participants to mats 430. FIGS. 6A and 6B show examples of the mats positioned so that the edges of the mats are interlocked. However, the mats may also be positioned apart so that they are not interlocked. One participant may be assigned to each mat, or multiple participants may be assigned to each mat if the video provides instruction in techniques requiring more than one participant 430. Next, the instructor plays the video 440, and the participants follow the instruction in the video 450. The instructor monitors the participants as they perform the activity instructed in the video 460. The instructor may provide additional instruction to all of the participants or to individual participants, as needed. For example, the instructor could correct the form or body position of a participant if the participant is not following the video correctly. Further, if the participants are children, the instructor can keep the participants focused on following the instruction that is being presented in the video. Additionally, the instructor can monitor the physical condition of the participants as they participate in the technique, and provide guidance if a participant is becoming overly tired or distressed.

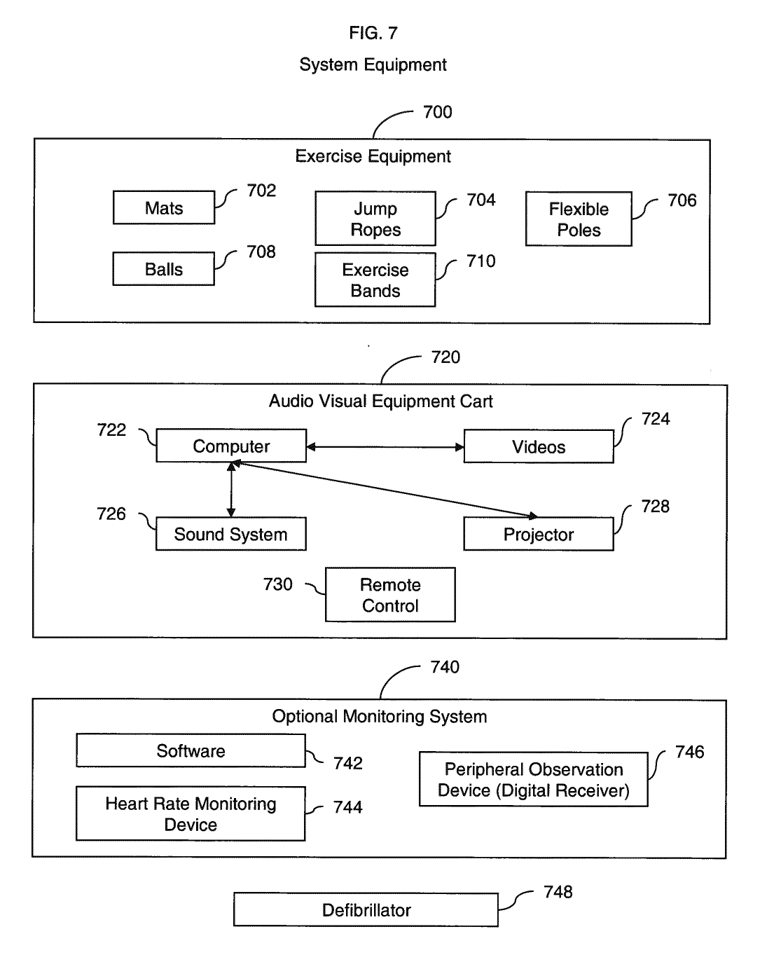

As shown in FIGS. 7 and 9, system equipment of an embodiment of the present invention may include exercise equipment 700 including, but not limited to, mats 702, balls 708, jump ropes 704, flexible poles 706, and exercise bands 710. The instructor may choose which equipment will be utilized for each training session, and assemble the equipment in a suitable configuration.

The system equipment may also include an audiovisual equipment cart 720 which may include, but is not limited to, a computer 722 on which videos 724 may be displayed, a sound system 726, a projector 728, and a wireless remote control 730. The computer 722 is utilized to display the visual component of the videos 724 on the projector 728, and play the audio component of the videos 724 on the sound system 726. The projector 728 may be utilized to project the visual component of the videos 724 onto any suitable viewing surface, including, but not limited to, a screen or a wall. The instructor may control the display of the videos 724 with the remote control 730 or by directly interfacing with the computer 722. The instructor chooses the video 724 to be utilized for the training session, initiates the display of the video 724, and pauses or stops the video 724. This instructor may choose to pause the video 724 to give additional instruction to the participants or to assist participants that need assistance.

In another embodiment of the present invention, the computer may be connected to an external sound system, such as one or more speakers or a pre-existing sound system which is installed in the building, and the audio component of the videos may be played through the external sound system.

The system equipment may also include an optional monitoring system 740, which may include software 742, to be installed on a computer, heart rate monitoring devices 744, such as heart rate belts, and a peripheral observation device (or digital receiver) 746. If the instructor decides to use the monitoring system 740, the instructor will have the participants wear the heart rate monitoring devices 744, which will determine the heart rate of the participant and wirelessly send this information to the peripheral observation device 746. The peripheral observation device 746 will send this information to the computer, where the instructor may choose to have the information displayed. The instructor may then monitor the heart rate information of the participants, and give the participants additional instructions based on this information, such as to increase or decrease the intensity of the participation.

The system equipment may also include an optional defibrillator 748.

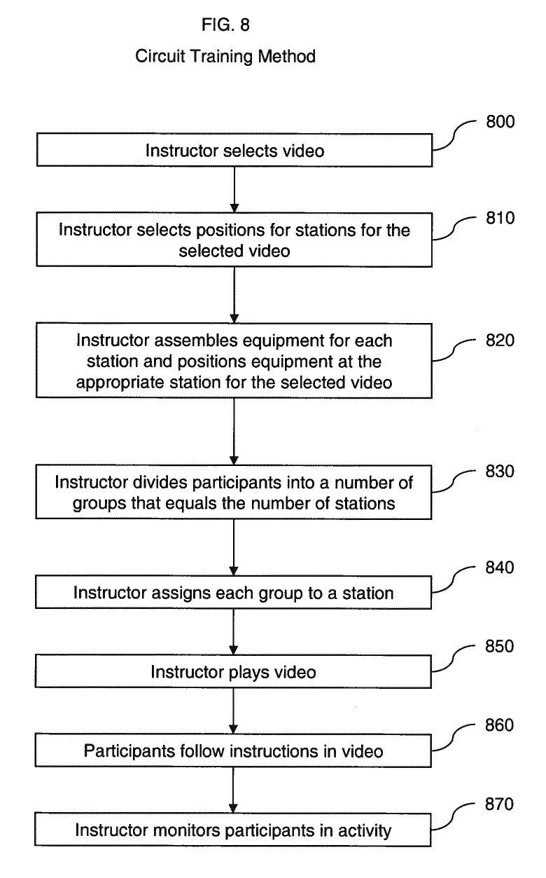

As shown in FIG. 8, an embodiment of the present invention includes a circuit training method. Here, the instructor selects a video 800 and positions for stations that correspond to the selected video 810. Next, the instructor assembles equipment for each station and positions the equipment at the appropriate station for the selected video 820. As shown in FIG. 9, this equipment may include, but is not limited to, exercise balls, mats, flexible poles, jump ropes, or exercise bands. Further, sections of the mat may be unlocked and configured to be hurdles and/or cones.

The instructor then divides the participants into groups that equal the number of stations 830 that are demonstrated in the video, and assigns each group to a station 840. The instructor then plays the video 850, and participants follow the instructions presented in the video 860. The instructor monitors the participants in the activity 870 to ensure proper technique and safety.

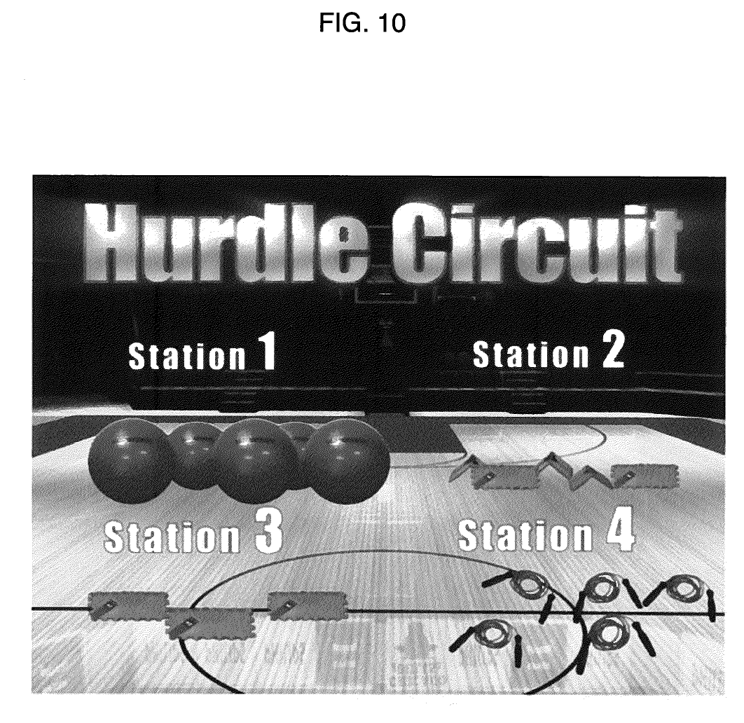

One example of the stations for the circuit training method is shown in FIG. 10. Here, Station 1 includes exercise balls, Station 2 includes sections of the mat configured as hurdles and positioned along a direction orthogonal to each other, Station 3 includes sections of the mat configured as hurdles and positioned along a direction parallel to each other, and Station 4 includes jump ropes. At Station 1, the video may instruct that the exercise balls be utilized by participants for abdominal work by reclining on the ball while the feet are on the floor, and raising and lowering the head. Alternatively, the video may instruct that the exercise balls be utilized by participants for exercising chest muscles by doing push-ups while the feet or the hands are positioned on the ball. At Stations 2 and 3, the video may instruct that participants jump over the hurdles on one foot or on two feet. At Station 4, the video may instruct that participants utilize the jump rope for jumping with both feet together or with alternating feet.

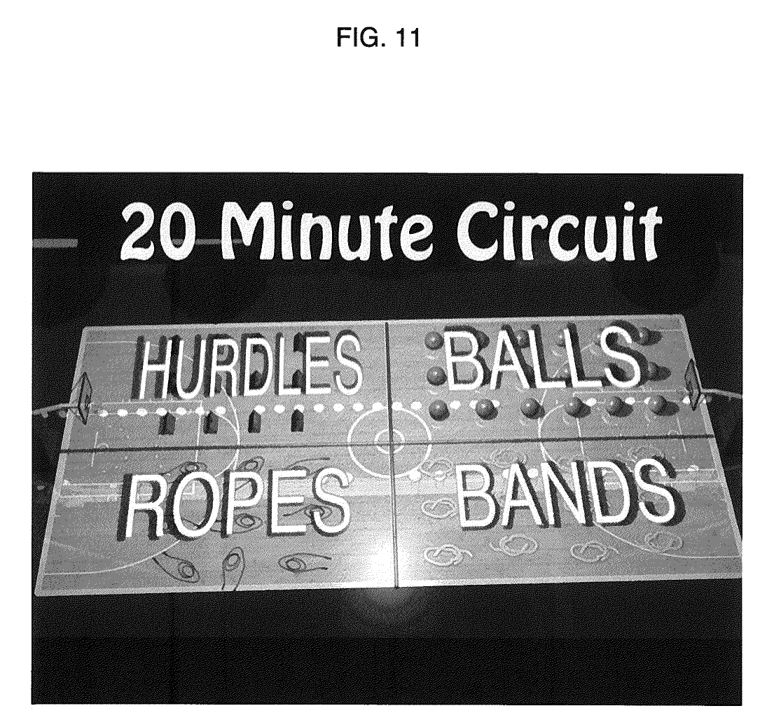

Another example of the stations for the circuit training method is shown in FIG. 11. Here, there is a station for hurdles, balls, ropes, and bands (e.g., exercise bands). The exercise bands, which are formed of a stretchable material such as rubber, may be utilized by the participants for a variety of strength training exercises. For example, the band may be held in a hand at each end, while the middle of the band is positioned under the feet. The participant may exercise the arms by bending at the elbow to strengthen bicep muscles or by extending the arms to the side to strengthen the shoulder muscles.

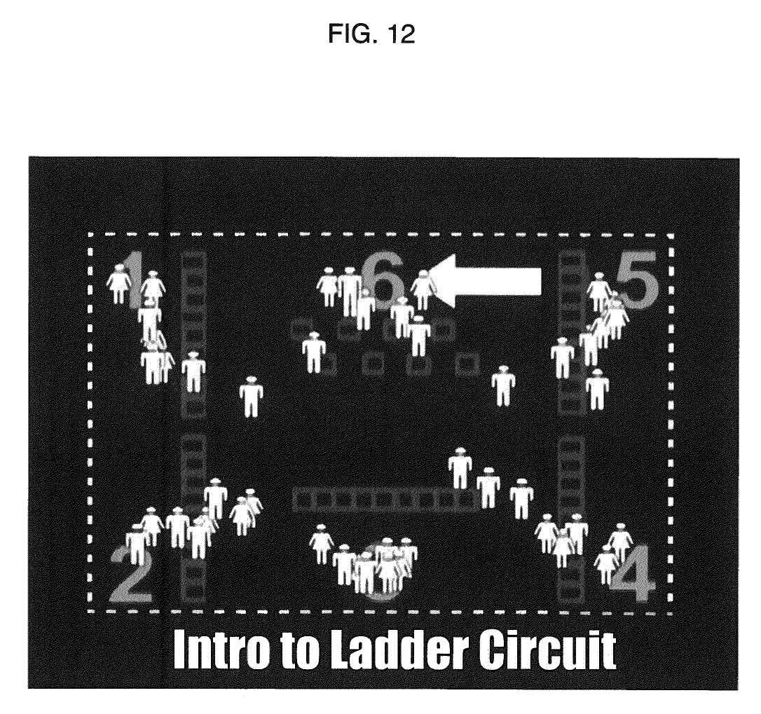

Another example of the stations for the circuit training method is shown in FIG. 12. Here, there are six stations that each require different configurations of the mat. In this example, a center region of each mat section is removed to form a square. The edges of the squares can be interlocked to form different configurations. For example, a ladder may be formed from multiple squares being interlocked along a direction. Here, the ladder is utilized in Stations 1 through 5. Participants may be instructed to jump forward, backward, or sideways with both feet or alternating feet into the openings of the squares of the ladder. Alternatively, participants may be instructed to jump into the openings of the squares, and then jump outside of the openings of the squares. In this example, at Station 6, the squares are not interlocked, and are positioned apart from each other. Here, participants may be instructed to make larger jumps between the squares, or do other types of exercises.

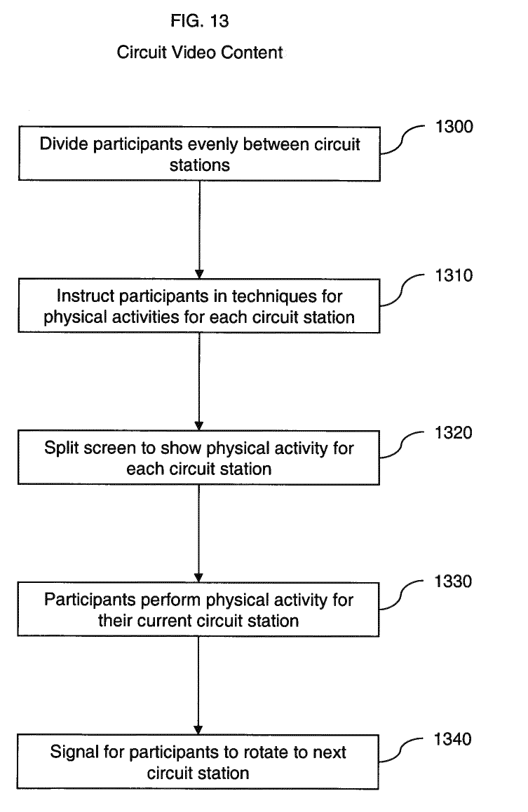

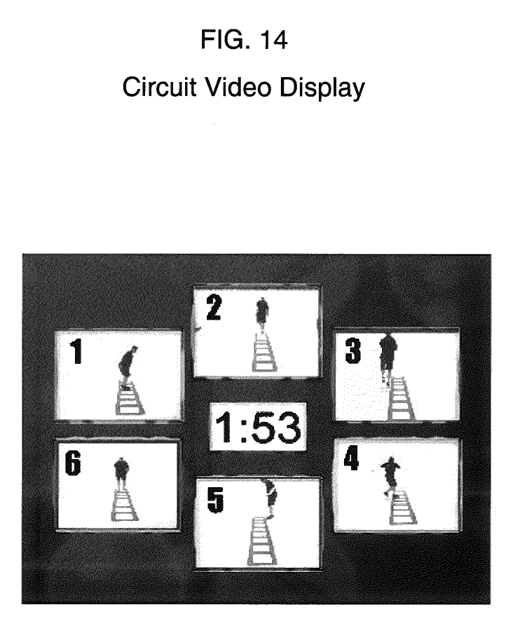

FIG. 13 shows an example of circuit video content. Here, the video instructs that the participants are to be divided evenly between the circuit stations 1300. Next, the video instructs the participants regarding the technique to be utilized at each circuit station 1310. Now, the video utilizes a split-screen type format to demonstrate the technique for each circuit station in different regions of the screen 1320, as shown in FIG. 14. The participants perform the physical activity demonstrated for their current circuit station 1330. The concurrent demonstration of multiple techniques is advantageous because all of the participants may refer to the screen for instruction at their current circuit station at the same time. As shown in FIG. 14, a timer may also be displayed on a region of the screen so that participants will know how long they have been doing the physical activity or how much longer they will have to do the physical activity. After the completion of the activity at the current station or when the allotted time has passed, the video signals that participants should rotate to the next station 1340. Therefore, the participants at Station 1 rotate to Station 2, the participants at Station 2 rotate to Station 3, and so forth. The participants at the last station rotate to Station 1.

Once participants have rotated through all of the stations, the video may instruct the participants regarding another technique to be utilized at each circuit station, which may be a new technique or a technique that has already been performed. Then, the same rotation procedure described above will be repeated. This procedure may be repeated from three to six times, but is not limited thereto.

Participants may take turns utilizing the equipment or performing the technique, or the participants may concurrently utilize the equipment or perform the technique. Further, multiple circuits may be set-up by the instructor if the number of participants is too large to effectively participate in a single circuit.

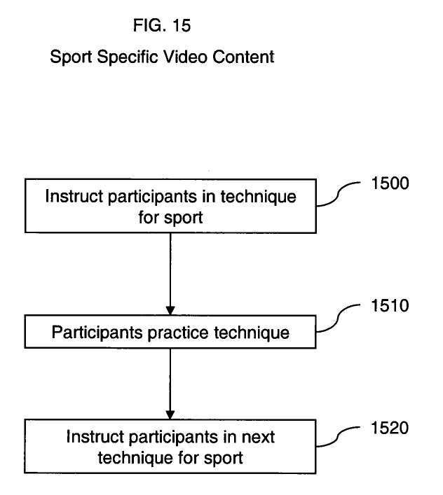

As shown in FIG. 15, sports specific video content may be utilized in another embodiment of the present invention. Here, the video instructs participants in a technique for a specific sport 1500. Next, the participants practice the technique while the video continues to show a demonstration of the technique 1510. The participants may utilize equipment while practicing the technique, or the participants may practice the technique without any equipment. After the completion of the technique practice, the video instructs the participants in the next technique for the sport 1520. The video may instruct participants in four to six techniques, but is not limited thereto. Well-known or famous athletes in the sport may appear on the video to give tips or demonstrate the techniques.

In an example of sports specific video content, hockey techniques may be demonstrated. Here, participants may utilize flexible poles, rather than an actual hockey stick to safely and conveniently practice the instructed techniques. An example of a hockey technique demonstrated may be puck control. The video may show a person demonstrating a puck control technique with a flexible pole and/or hockey stick. The participants then practice the puck control technique with either flexible poles and/or hockey sticks. The video would then demonstrate another hockey technique.

In another example of sports specific video content, soccer techniques may be demonstrated. Here, participants may or may not utilize an actual soccer ball. An example of a soccer technique may be stopping the ball. The video may show a person demonstrating a ball stopping technique with and/or without a soccer ball. The participants then practice the ball stopping technique with and/or without soccer balls. The video would then demonstrate another soccer technique.

In another example of sports specific video content, football techniques may be demonstrated. Here, participants may or may not utilize an actual football. For example, the video may demonstrate a football kicking technique. The participants then practice the football kicking technique with and/or without footballs. The video would then demonstrate another football technique.

In another example of sports specific video content, baseball techniques may be demonstrated. Here, participants may or may not utilize an actual baseball or bat. Participants may utilize flexible poles, rather than an actual baseball bat to safely and conveniently practice the instructed techniques. For example, the video may demonstrate a baseball swing technique with a flexible pole and/or a baseball bat. The participants then practice the baseball swing technique with either flexible poles and/or baseball bats. The video would then demonstrate another baseball technique.

In another example of sports specific video content, swimming techniques may be demonstrated. Here, participants may utilize an exercise ball to practice the swimming techniques. For example, the video may demonstrate a swimming stroke, such as the backstroke. The participants then practice the backstroke while reclining on their backs on the exercise balls. The video would then demonstrate another swimming technique.

In another example of sports specific video content, volleyball techniques may be demonstrated. Here, participants may or may not utilize actual volleyballs. For example, the video may demonstrate a volleyball passing technique. The participants would then practice the volleyball passing technique with and/or without volleyballs. The video would then demonstrate another volleyball technique.

In another example of sports specific video content, golf techniques may be demonstrated. Here, participants may or may not utilize an actual golf club. Participants may utilize flexible poles, rather than an actual golf club to safely and conveniently practice the instructed techniques. For example, the video may demonstrate a golf club swing technique with a flexible pole and/or a golf club. The participants then practice the golf club swing technique with either flexible poles and/or golf clubs. The video would then demonstrate another golf technique.

In another example of sports specific video content, martial arts techniques may be demonstrated. For example, the video may demonstrate a martial arts technique, such as a punch technique. The participants then practice the punch technique. The video would then demonstrate another martial arts technique.

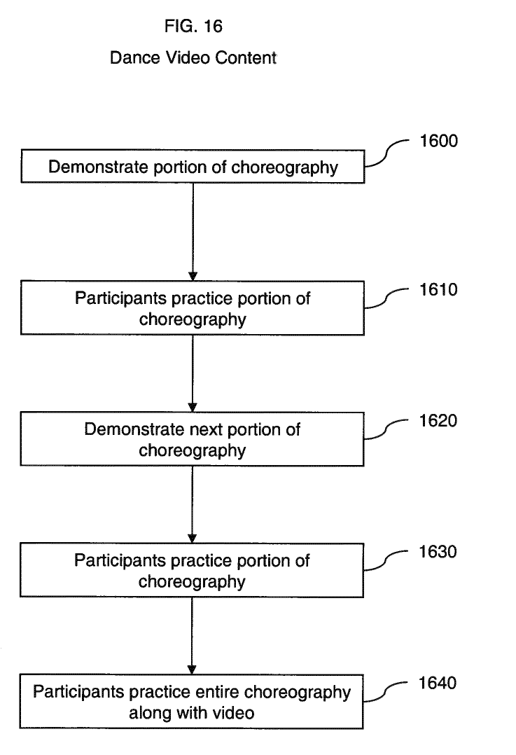

As shown in FIG. 16, dance video content may be utilized in another embodiment of the present invention. Here, the video demonstrates a portion of choreography for a dance 1600, such as jazz, hip-hop, or break dancing. Next, participants practice that portion of the choreography 1610. The video then demonstrates another portion of the choreography 1620, and the participants practice this portion of the choreography 1630. Once the participants have practiced all of the choreography, the participants practice the entire choreography of the dance along with the video 1640.

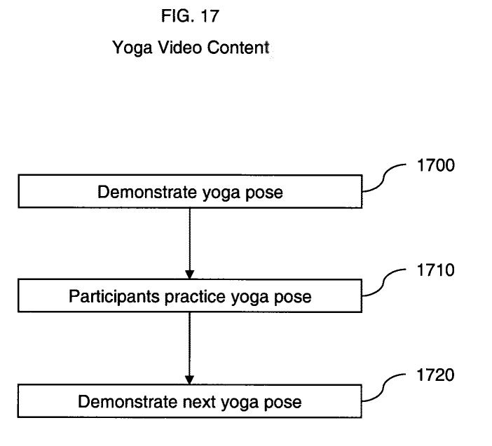

As shown in FIG. 17, yoga video content may be utilized in another embodiment of the present invention. Here, the video demonstrates a yoga pose 1700. Next, participants practice the yoga pose 1710. Then, the video demonstrates another yoga pose 1720, which the participants will practice. The video may demonstrate ten to twenty poses, but is not limited thereto.

Pilates video content may be utilized in another embodiment of the present invention. Here, the video demonstrates a Pilates exercise. Next, participants practice the Pilates exercise. Then, the video demonstrates another Pilates exercise, which the participants will practice. The video may demonstrate ten to twenty Pilates exercises, but is not limited thereto.

In another embodiment of the present invention, entertaining music may play in the background of the video. In another embodiment of the present invention, interesting and/or attractive background graphics may be utilized in the videos. In another embodiment of the present invention, this method of instruction may be utilized to teach other activities, such as beat-boxing (i.e., vocal percussion popularly utilized in hip-hop style music), meditation, or how to use a heart defibrillator.

In another embodiment of the present invention, the instructor evaluates data from a heart rate monitor for each participant to determine safety and effectiveness. For example, if the heart rate of a participant is too fast to be safe, the instructor may instruct the participant to decrease the intensity level of participation. Further, if the heart rate of a participant is too low to adequately exercise the heart, the instructor may instruct the participant to increase the intensity level of the participation.

In another embodiment of the present invention, the instructor may choose to display videos, such as the circuit videos or the warm-up videos, in a particular order over a period of time. For example, there may be multiple circuit videos displaying the same exercise technique(s). The instructor may choose a first video that teaches techniques with a background music track. The instructor may choose to continue to display the video (over a time period of days or weeks) until the instructor determines that the participants are proficient at the techniques.

After the instructor determines that the participants are proficient at the techniques, the instructor may choose a second video that teaches the same techniques as the first video that has no background music track. Here, the instructor may choose different music (such as music from another source like CDs, MP3s, or iTunes) to play while the video is displayed, and the instructor may continue to play the second video with different music for as long a time period as the instructor deems appropriate.

The instructor may determine at some time to display a third video that teaches the same techniques as the first and second video. However, the third video may also include information in a split-screen format. Here, the video may continue to show the same techniques in at least one region of the display, while other information is shown in other regions of the display. This other information could include entertainment, news clips, cartoons, nutritional information, health information, or other educational information or quizzes. Further, the instructor might assign the participants to complete a quiz based on information contained in the third video, which might be an online or web-based quiz.

What is claimed is:

1. A method for group teaching of physical activity, the method comprising:
selecting a video, wherein the video displays instructions for at least one physical activity;
assembling selected exercise equipment, wherein the exercise equipment is selected based on the instructions displayed in the video and a number of participants in the group;
positioning the exercise equipment in selected positions, wherein the exercise equipment is positioned based on the instructions displayed in the video;
assigning participants to stations, wherein the participants are assigned to the stations based on the instructions displayed in the video;
playing the video, wherein the participants are instructed to participate in the at least one physical activity by following the instructions displayed in the video; and
monitoring compliance, technique, and condition of the participants as the participants perform aspects of the at least one physical activity, wherein the physical fitness of the participants is improved by performance of the at least one physical activity.

2. The method of claim 1, wherein the video displays a split screen format, wherein a portion of the screen displays an aspect of the at least one physical activity and another portion of the screen displays a subject selected from a group of subjects comprising educational information, nutritional information, test questions, test question answers, and entertainment.

3. The method of claim 1, wherein the video displays a split screen format, wherein a portion of the screen displays an aspect of the at least one physical activity and another portion of the screen displays another aspect of the at least one physical activity.

4. The method of claim 1, wherein the video displays instructions for circuit training by instructing participants to rotate through at least two stations and the method further comprises:
selecting positions for each station, wherein the positions are selected based on instructions displayed in the video; and
dividing the participants into a number of groups that equals the number of stations.

5. The method of claim 4, wherein the video displays a split screen format, wherein a portion of the screen displays a physical activity for a station and another portion of the screen displays a different physical activity for a different station.

6. The method of claim 1, wherein the exercise equipment is selected from a group of exercise equipment comprising a configurable mat that can be configured into suitable sizes or configured as a hurdle, a mat, or a ladder; a ball; a jump rope; an exercise band; and a flexible pole.

7. The method of claim 1, wherein the exercise equipment comprises a mat, wherein the mat comprises labeled regions that correspond to instructions displayed in the video.

8. The method of claim 1, the method further comprising:
playing the video on a computer located on an audio visual equipment cart, wherein the audio portion of the video is played through a sound system, and the visual portion of the video is played through a projector located on the audio visual equipment cart.

9. The method of claim 1, the method further comprising monitoring the heart rate of at least one participant by locating a heart rate monitoring device that transmits a signal on the at least one participant, and receiving the signal with a peripheral observation device, wherein the peripheral observation device sends the signal to a computer with software for recording the heart rate of the at least one participant.

10. The method of claim 1, wherein the video displays instructions for at least one technique for the at least one physical activity, which at least one physical activity is selected from the group comprising: football, soccer, swimming, yoga, dance, baseball, Pilates, martial arts, golf, volleyball, and hockey.

11. A physical education system, the system comprising:
a selected video, wherein the video displays instructions for at least one physical activity; and
exercise equipment, wherein the exercise equipment is selected based on the instructions displayed in the video and a number of participants in the group;
wherein the exercise equipment is assembled and positioned based on the instructions displayed in the video, the participants are assigned to the exercise equipment based on the instructions displayed in the video, the participants participate in the at least one physical activity by following the instructions displayed in the video, and compliance, technique, and condition of the participants is monitored as the participants perform the at least one physical activity.

12. The physical education system of claim 1, wherein the video displays a split screen format, wherein a portion of the screen displays an aspect of the at least one physical activity and another portion of the screen displays a subject selected from a group of subjects comprising educational information, nutritional information, test questions, test question answers, and entertainment.

13. The physical education system of claim 1, wherein the video displays a split screen format, wherein a portion of the screen displays an aspect of the at least one physical activity and another portion of the screen displays another aspect of the at least one physical activity.

14. The physical education system of claim 1, wherein the video displays instructions for circuit training by instructing participants to rotate through at least two stations and the method further comprises:
selecting positions for each station, wherein the positions are selected based on instructions displayed in the video; and
dividing the participants into a number of groups that equals the number of stations.

15. The physical education system of claim 14, wherein the video displays a split screen format, wherein a portion of the screen displays a physical activity for a stations and another portion of the screen displays a different physical activity for a different station.

16. The physical education system of claim 1, wherein the exercise equipment is selected from a group of exercise equipment comprising a configurable mat that can be configured into suitable sizes or configured as a hurdle, a mat, or a ladder; a ball; a jump rope; an exercise band; and a flexible pole.

17. The physical education system of claim 16, wherein the exercise equipment comprises a mat, wherein the mat comprises labeled regions that correspond to instructions displayed in the video.

18. The physical education system of claim 1, wherein the video is played on a computer located on an audio visual equipment cart, wherein the audio portion of the video is played through a sound system, and the visual portion of the video is played through a projector located on the audio visual equipment cart.

19. The physical education system of claim 1, wherein the heart rate of at least one participant is monitored by locating a heart rate monitoring device that transmits a signal on the at least one participant, and receiving the signal with a peripheral observation device, wherein the peripheral observation device sends the signal to a computer with software for recording the heart rate of the at least one participant

20. The physical education system of claim 1, wherein the video displays instructions for at least one technique for the at least one physical activity, which at least one physical activity is selected from the group comprising: football, soccer, swimming, yoga, dance, baseball, Pilates, martial arts, golf, volleyball, and hockey.
